(19) United States
(12) Patent Application Publication
(10) Pub. No.: US 2009/0013597 A1
(43) Pub. Date: Jan. 15, 2009

(54) Landscape edging strips

(76) Inventor: David S. Orton, Princeton, MN (US)

Correspondence Address: Terry M. Crellin, 204 W 330 North, LaVerkin, UT, 84745, US

(21) Appl. No.: 12/217,599

(22) Filed: Jul. 3, 2008

Related U.S. Application Data
(60) Provisional application No. 60/959,257, filed on Jul. 13, 2007.

(51) Int. Cl. A01G 1/08

(52) U.S. Cl. 47/33

(57) ABSTRACT

A paver restraint comprises an extruded length of plastic that has a general cross-sectional shape of an ell or an angle iron, having a generally flat upwardly extending upper rectangular section and a lower or second rectangular section extending substantially perpendicularly from the lower edge of the upper section along the length of the upper section. A plurality of openings are formed in the lower rectangular section, with the openings being spaced from each other so that the legs of elongate, u-shaped staples can be received through adjacent slots or openings and driven into the ground to securely hold the paver restraint in position on the ground.

### CROSS REFERENCE TO RELATED APPLICATION

This application claims the priority from U.S. Provisional Patent Application No. 60/959,257 filed on Jul. 13, 2007.

### BACKGROUND OF THE INVENTION

1. Field of the Invention

This invention relates to an improvement in landscape edging strips adapted to be employed in landscaping and pavement areas in which the strips fit around paving blocks. Such edging strips are often referred to as paver restraints. The invention in particular is concerned with a divider construction adapted to be employed for dividing a lawn or other area from another area such as a flower bed or a paved area.

2. State of the Art

The use of dividers for landscaping purposes and as paver restraints is well known. In the past, dividers were formed of wood, concrete or metal. Wood dividers were considered unsightly and bulky and they required relatively frequent painting. In addition, they had to be replaced periodically due to the fact that they would readily rot under most conditions.

Metal dividers were subject to corrosion, and/or they could also be readily bent or otherwise damaged, particularly when stuck by mowers, edgers, spreaders, wheelbarrows or other lawn care equipment. Thin sheet metal dividers were also a hazard because they presented relatively sharp cutting edges. Concrete dividers were and are still satisfactory from a performance standpoint; however, the installation of such dividers remains prohibitively expensive in most cases.

A divider is shown in U.S. Pat. No. 5,640,801 that was directed to elimination of various problems encountered when employing dividers, for example in situations which involve the use of beds formed outside the walls of a building to catch water dripping from the eaves. Such beds eliminate damage to the sod and they avoid the splashing of mud on the sides of the building. Shrubbery is often planted within the beds to suit landscaping plans. The divider of U.S. Pat. No. 5,640,801 comprised an extruded length of plastic including an enlarged upper section. An integrally formed flange extended downwardly from the upper section and was adapted to be substantially completely inserted in the ground whereby the upper section was located immediately above the top surface of the ground while the flange acted as a barrier to the growth of grass, roots and the like into the plot. The flange means comprised a relatively narrow portion extending substantially completely along the length of said upper section, and a projecting portion attached to the flange adjacent the bottom edge thereof assisted in securing the flange in place. Stakes could be driven through the projecting portion to hold the divider firmly in place, and gravel or soil would be used to bury the flange and stakes.

Paving or paver blocks are used commonly in landscaping to achieve both a decorative and a utilitarian function. The natural freezing and thawing cycles of the ground upon which paver blocks are laid, as well as vehicular and pedestrian traffic over the paver blocks, causes movement of the blocks. Such movement destroys both the decorative and the utilitarian function of the blocks. It becomes desirable to hold the paving blocks in place, and various edge support arrangements exist to hold paving blocks in place.

A typical paver restraint system is shown in U.S. Pat. No. 5,240,343. This system includes a vertical side for contacting the paving blocks which is buttressed by gusset members, which, in turn, are supported by a boss member. The boss member provides for driving a stake into the underlying soil in order to hold the vertical side in place. This system is a one-piece injection molded device which is capable of use for restraining curved areas of a paving surface, if certain portions of the restraint system are removed (cut-out) by the user. Additional restraint systems are shown in U.S. Pat. Nos. 4,831,776; 5,212,917; and 5,375,941.

### SUMMARY OF THE INVENTION

In accordance with this invention, a divider and/or paver restraint is provided for defining the limits of a flower bed or especially a paved area comprising paver blocks and the like relative to adjoining ground. The divider or paver restraint comprises an extruded length of plastic that has a general cross-sectional shape of an ell or an angle iron. The divider or paver restraint has a generally flat upwardly extending upper section which takes the form of an elongated rectangle. A lower or second section, having a generally flat rectangular form, is formed integrally with the upper section and extends substantially perpendicularly from the lower edge of the upper section along the length of the upper section. A plurality of slots or openings are formed in the lower section, with the slots or openings being spaced from each other so that the legs of elongate, u-shaped staples can be received through adjacent slots or openings and driven into the ground upon which the restraint is placed. The base of the u-shaped staples interconnect respective ends of the staples as are well known in the art, and the base of the staples abuts against the portion of the lower section that is between the slots or openings when the staples are driven through the slots or opening into the ground.

The staples have been found to be particularly effective in securing the divider or paver restraint to the ground. In addition, it is advantageous to terminate the opposite ends of the divider or paver restraint from an adjacent slot or opening by one-half the distance between the other slots or openings in the lower section of the divider or paver restraint. This is particularly suited for applications wherein two or more dividers or paver restraints are installed in end-to-end relationship. The slots or openings in the abutting ends of respective dividers or paver restraints can then receive a staple such that the base of the staple engages the end portion of each of the abutting dividers or paver restraints and thus securely holds both ends of the dividers or paver restraints securely in position abutting each other. This is particularly advantageous when the dividers or paver restraints are adapted to be curved so as to form an arcuate section. The abutting ends of such curved sections of dividers or paver restraints are held securely abutting each other by the staples.

### BRIEF DESCRIPTION OF THE DRAWINGS

FIG. 1 is a fragmentary perspective view of one embodiment of a divider or paver restraint in accordance with the present invention;

FIG. 2 is a top view of the divider or paver restraint of FIG. 1;

FIG. 3 is a fragmentary side elevation of the divider or paver restraint of FIG. 1 taken from the left hand side of the divider or paver restraint as shown in FIG. 1;

FIG. 4 is an end elevation of the divider or paver restraint of FIG. 1 taken from the lower end of the divider or paver restraint as shown in FIG. 1;

FIG. 5 is an end elevation of the divider or paver restraint of FIG. 1 taken from the upper end of the divider or paver restraint as shown in FIG. 1;

FIG. 6 is a fragmentary perspective view of another embodiment of a divider or paver restraint in accordance with the present invention;

FIG. 7 is a top view of the divider or paver restraint of FIG. 1;

FIG. 8 is a fragmentary side elevation of the divider or paver restraint of FIG. 1 taken from the left hand side of the divider or paver restraint as shown in FIG. 6;

FIG. 9 is an end elevation of the divider or paver restraint of FIG. 1 taken from the lower end of the divider or paver restraint as shown in FIG. 6;

FIG. 10 is an end elevation of the divider or paver restraint of FIG. 1 taken from the upper end of the divider or paver restraint as shown in FIG. 6; and

FIG. 11 is a perspective view of a staple that is used to hold the divider or paver restraint of the present invention to the ground.

### DESCRIPTION OF THE PREFERRED EMBODIMENTS

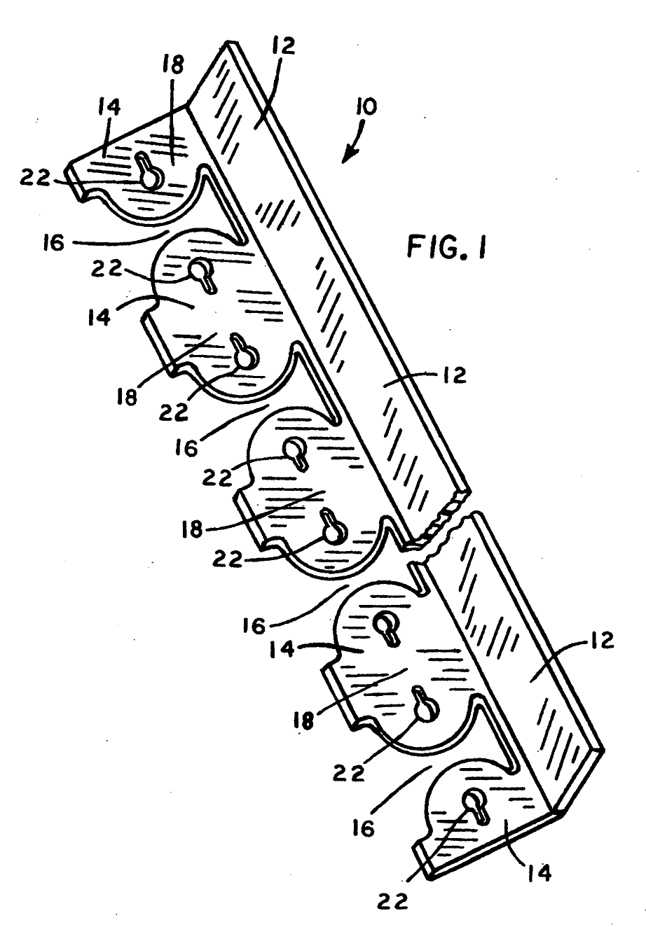

Two particularly preferred embodiments of the divider or paver restraint of the present invention are illustrated in the drawings. In the embodiment shown in FIG. 1, the divider or restraint 10 comprises a one-piece longitudinal member formed of extruded polymeric material, and consisting of an elongated, rectangular upper section or vertical plate 12 and a lower section or lateral plate 14 that is formed integrally with the upper section 12 and extends outwardly from the bottom edge of the upper section 12 at a substantially perpendicular angle to the upper section 12. The overall shape of the divider or restraint 10 is thus similar to an angle iron having a substantially L-shaped cross section.

The upper or vertical plate or section 12 preferably has a continuous surface so as to form a solid rectangular shape. However, there could be some open spaces or cut out openings spaced apart from each other along the longitudinal length of the section 12 if it is desired to limit the weight or the amount of material used in the upper plate or section 12. The longitudinal upper and lower edges of the plate or section 12 are continuous without any break in them. The length of the upper plate or section 12, and thus the effective length of the divider or restraint 10 can vary over a large range from several feet to 16 feet or more. Preferably, the length of the divider or restraint 10 will be between about 4 feet and 15 feet. The thickness of the upper or vertical plate 12 can also vary. Preferably, that thickness will be between about ⅛ inch and ¼ inch, most preferably about 3/16 inch.

The lateral section or plate 14 has essentially the same length and thickness as the upper section or plate 12, and as mentioned previously is formed integrally with the upper plate 12 so as to extends substantially perpendicular from the upper plate 12 at the lower edge of the upper plate 12. The lateral plate 14 will generally have a width, i.e., dimension extending outwardly from the upper plate 12, that is somewhat greater than the height of the upper plate 12. The upper plate 12 can have a height of between about 1 inch or less and 2.5 inches or greater, with the lateral plate 14 having a width of between about 2 inches or less and 3.5 inches or greater. The outer sidewall of the upper plate 12 that faces away from the lateral plate is intended to abut paving blocks when installed in a paving system. The lower sidewall of the lateral plate 14 that faces away from the upper plate 12 is intended to contact the ground upon which the divider or retainer 10 is positioned.

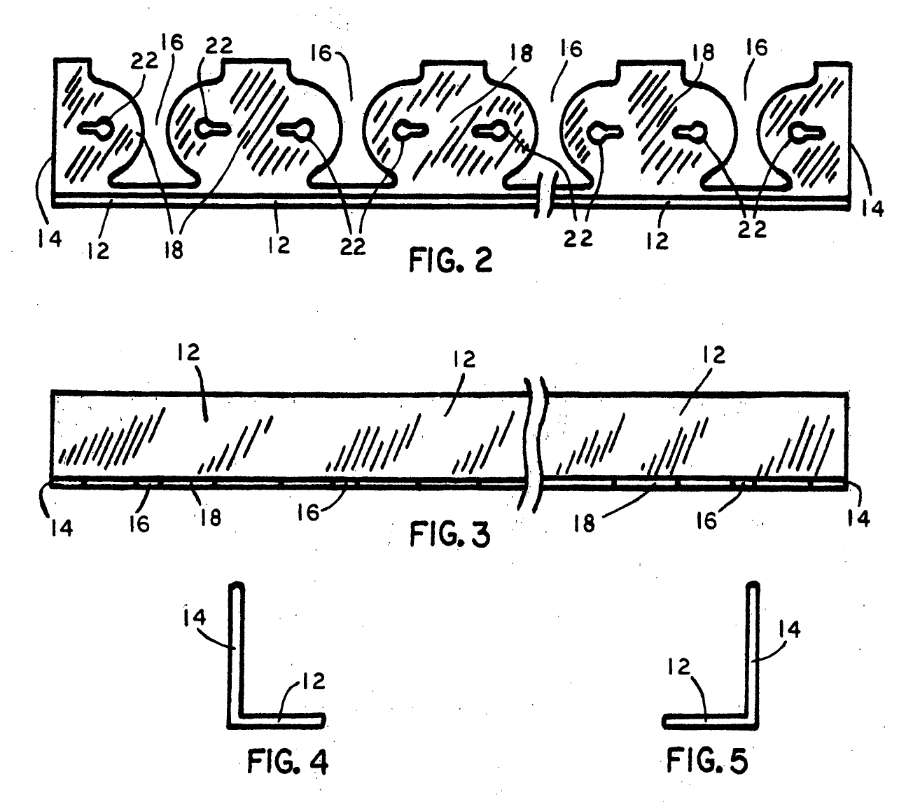

In the embodiment of the invention as illustrated in FIGS. 1-5, the lateral plate 14 has a plurality of cut out openings 16 spaced along the length of the plate 14. These openings 16 extend inwardly from an outer, distal edge of the lateral plate 14. The openings 16 can extend all the way to the juncture with the vertical plate 12, or as illustrated in the drawings the openings 16 can approach closely to the vertical plate 12. The openings 16 can have various shapes. It is important that the spacing of the openings 16 is sufficient to provide solid sections 18 that have a longitudinal dimension along the longitudinal direction of the plate 14 of about 2 inches or less to 3.5 inches or greater. These openings 16 allow the divider or retainer 10 to be formed into curvilinear shape by flexing and bending of the vertical plate 14. The vertical plate 14 can be flexed in one direction so that the open space between solid sections 18 of the lateral plate 14 increase and in the other direction so that the open space between solid sections 18 of the lateral 14 decreases or closes. This allows the divider or retainer 10 of FIGS. 1-5 to be formed into smooth, curvilinear shapes as is desirable in many landscaping applications.

A pair of receiver openings 22 are spaced apart from each other in each of the solid sections 18 of the lateral plate 14 of the divider or retainer 10 as shown in FIGS. 1-5. The receiver openings 22 are spaced from each other by a distance sufficient to receive staples 30 (a staple is shown in FIG. 11). The staples 30 have a generally block u-shape, with the base or crown 32 of the staples 30 having a dimension to span the distance between spaced apart receiver openings 22. The legs 34 of the staples 30 can have various lengths and preferably about 10 inches or greater. The staples 30 are preferably formed from 8 gauge metal wire, but could be made of other materials such as polymeric material. The legs 34 of the staples 30 are driven into the ground upon which the divider or retainer 10 is placed with the base or crown 32 lying against the portion of the solid sections 18 to hold the divider or retainer 10 in place on the ground.

Each of the extreme ends of the lateral plate 14 of the divider or retainer 10 has a receiver opening 22 which is spaced from the respective end of the lateral plate 14 by a distance of about one-half the distance between the receiver openings 22 in the remainder of the lateral plate 14 of the divider or retainer 10. When two dividers or retainers 10 are aligned with respective ends abutting each other, a single staple 30 can be driven into the ground so that one leg 34 of the staple 30 is received through the receiver opening 22 in the end of the first divider or retainer 10 and the other leg 34 of the staple 30 is received in the receiver opening 22 in the end of the second divider or retainer 10, with the base or crown 32 lying across each of the respective ends of the two dividers or retainers 10 so as to hold the two ends together in their desired abutting positions.

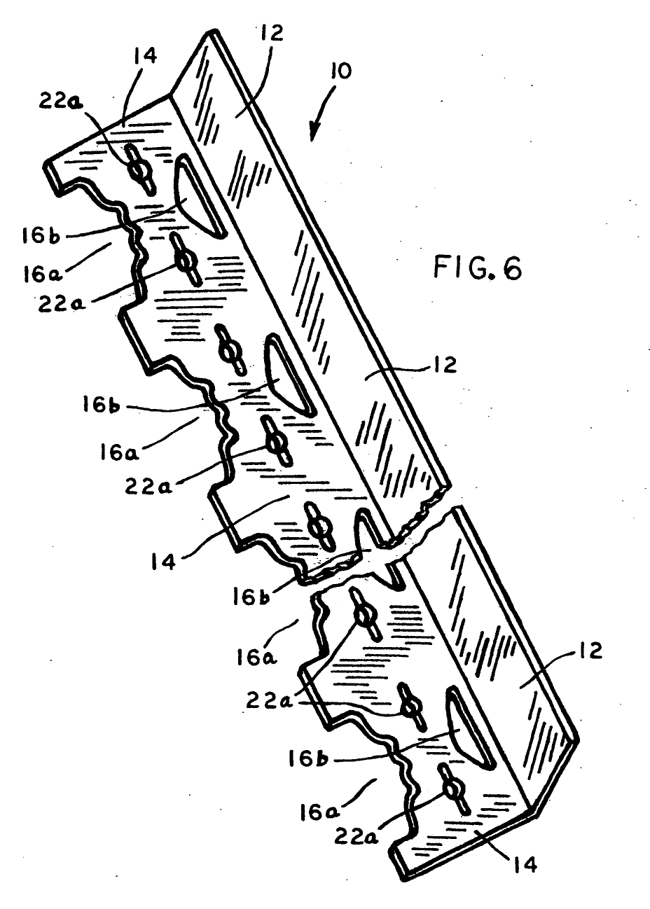

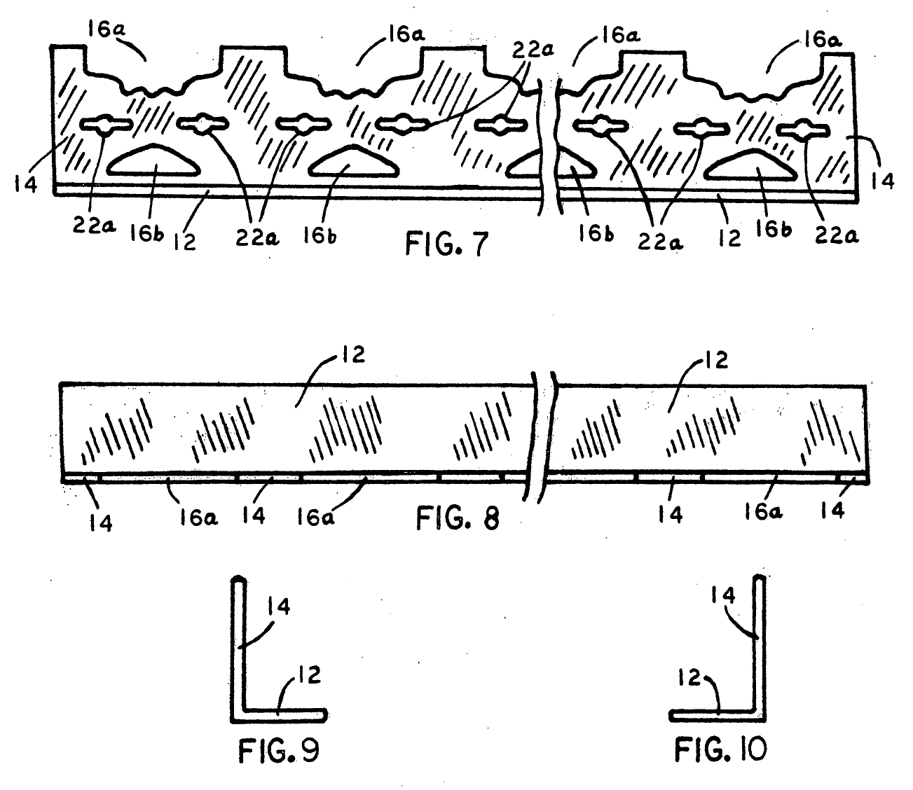

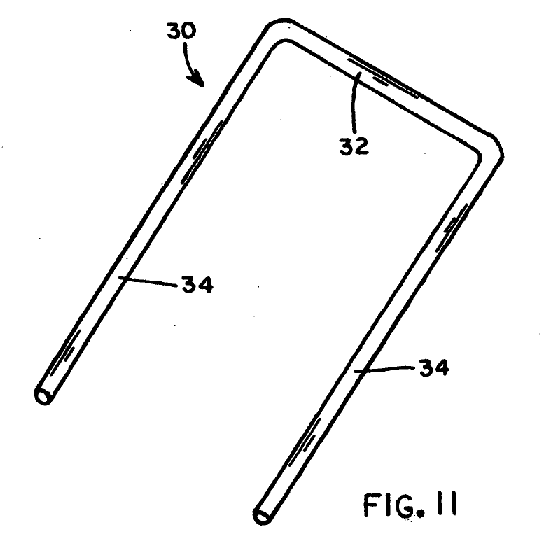

As illustrated in the embodiment of the divider or retainer 10 shown in FIGS. 1-5, the receiver openings 22 have elongated shapes with a circular portion being formed at one end so that the second end comprises a slot extending from the circular portion. The slots are aligned along a common axis that in turn passes through the centers of the circular portions. The circular portion can be used to receive a nail (not shown in the drawings) if it is desired to hold the divider or retainer 10 to the ground with nails instead of staples 30 or in addition to the staples 30. As illustrated, the receiver openings 22 are oriented so that the slot ends of each pair of openings 30 in each of the solid sections 18 face each other. However, any orientation of the circular portion can be utilized, and as will be described with reference to the embodiment of the invention shown in FIGS. 6-10, the circular portion of the openings 22 can be centered with two slots extending diametrically from the circular portion.

Another embodiment of the invention is illustrated in FIGS. 6-10 of the drawings. This latter embodiment is very similar to the previously described embodiment. The divider or restraint 10 again comprises a one-piece longitudinal member formed of extruded polymeric material, and consists of an elongated, rectangular upper section or vertical plate 12 and a lower section or lateral plate 14 that is formed integrally with the upper section 12 and extends outwardly from the bottom edge of the upper section 12 at a substantially perpendicular angle to the upper section 12. The overall shape of the divider or restraint 10 is thus similar to an angle iron having a substantially L-shaped cross section.

In the embodiment of the invention as illustrated in FIGS. 6-10, the lateral plate 14 has a plurality of cut out openings 16a spaced along the length of the plate 14. These openings 16a can extend inwardly from an outer, distal edge of the lateral plate 14, but they do not extend all the way to the juncture with the vertical plate 12. In addition to the openings extending inwardly from the outer edge of the lateral plate 12, enclosed openings 16b can be spaced along the lateral plate as shown. The openings 16a and 16b can have various shapes. It is important that the spacing and orientation of the openings 16a and 16b is such that the lateral plate 14 remains rigid. This embodiment of the invention provides rigid dividers or restraints 10 that retain a straight, rigid shape.

A plurality of receiver openings 22a are spaced apart from each other in essentially a straight line along the longitudinal length of the lateral plate 14. The receiver openings 22a are spaced from each other by a distance sufficient to receive staples 30 (a staple is shown in FIG. 11). As previously described, the staples 30 have a generally block u-shape, with the base or crown 32 of the staples 30 having a dimension to span the distance between spaced apart receiver openings 22a. The legs 34 of the staples 30 can have various lengths and preferably about 10 inches or greater. The staples 30 are preferably formed from 8 gauge metal wire, but could be made of other materials such as polymeric material. The legs 34 of the staples 30 are driven into the ground upon which the divider or retainer 10 is placed with the base or crown 32 lying against the portion of the lateral plate 14 between the receiver openings 22a to hold the divider or retainer 10 in place on the ground.

Each of the extreme ends of the lateral plate 14 of the divider or retainer 10 has a receiver opening 22a which is spaced from the respective end of the lateral plate 14 by a distance of about one-half the distance between the receiver openings 22a in the remainder of the lateral plate 14 of the divider or retainer 10. When two dividers or retainers 10 are aligned with respective ends abutting each other, a single staple 30 can be driven into the ground so that one leg 34 of the staple 30 is received through the receiver opening 22a in the end of the first divider or retainer 10 and the other leg 34 of the staple 30 is received in the receiver opening 22a in the end of the second divider or retainer 10, with the base or crown 32 lying across each of the respective ends of the two dividers or retainers 10 so as to hold the two ends together in their desired abutting positions.

As illustrated in the embodiment of the divider or retainer 10 shown in FIGS. 1-5, the receiver openings 22a have elongated shapes with a central circular portion and two slots extending from the circular portion. The circular portion can be used to receive a nail (not shown in the drawings) if it is desired to hold the divider or retainer 10 to the ground with nails instead of staples 30 or in addition to the staples 30. It should be recognized that the positioning of the circular portion can be varied. The circular portion could be provided at the end of the slot as previously described with respect to the embodiment shown in FIGS. 1-5, or placed anywhere along the length of the slot associated therewith.

1. A landscape edging system comprising
an extruded length of polymeric material having a general cross-sectional shape of an angle iron, with a generally flat first side wall extending from a longitudinal side edge of a generally flat second side wall, said second side wall being oriented substantially perpendicular to said first side wall, with said first side wall extending from said side edge of said second side wall along substantially a full length of said second side wall;
a plurality of openings formed in said second side wall, with said openings being substantially aligned along a common axis that extends along said length of said second side wall;
each of said openings being spaced from a respective adjacent one of said openings by a uniform distance;
a plurality of staples, with each of said staples having a shape similar to a block “U” with a substantially straight base interconnecting respective ends of a pair of elongate, substantially straight legs, said straight legs extending substantially perpendicular from said base, with said base and said straight legs being oriented so as to lie substantially in a common plane;
said base of each of said staples having a length that will span said uniform distance between respective adjacent pairs of said openings so that when said straight legs of said staple are driven through a respective adjacent pair of said openings and into ground upon which said edging system is placed, said base of each of said staples firmly contacts said uniform distance between said respective adjacent pair of openings thereby securely retaining said edging system to said ground.

2. The landscape edging system in accordance with claim 1 wherein each of said openings has a shape conforming to a circular space with a slot extending from a circumference of said circular space, and said slot is aligned along a longitudinal axis passing through centers of said circular spaces of said plurality of openings.

3. The landscape edging system in accordance with claim 1 wherein each of said openings has a shape conforming to a circular space with two oppositely directed slots extending from a circumference of said circular space, and said two slots are aligned along a longitudinal axis passing through centers of said circular spaces of said plurality of openings.

4. The landscape edging system in accordance with claim 1 wherein each of said openings that are adjacent to respective opposite ends of said second side wall is spaced from each of such respective opposite ends of said second side wall by a distance of about one-half of said uniform distance between respective adjacent pairs of said plurality of said openings.

5. The landscape edging system in accordance with claim 1 wherein said second side wall has a plurality of spaced apart cut out open spaces that extend inwardly from an outer longitudinal free edge of said second side wall, with said cut out open spaces located between respective adjacent pairs of said openings.
